(19) United States
(12) Patent Application Publication
(10) Pub. No.: US 2025/0252339 A1
(43) Pub. Date: Aug. 7, 2025

(54) Machine Learning Modeling Framework for Processing Pipeline Driven Implementations

(71) Applicant: The Toronto-Dominion Bank, Toronto (CA)

(72) Inventors: Chad A. Koziel, Toronto (CA); Paulina Corona Ugalde, Toronto (CA); Kevin Joe Akaoka, Toronto (CA)

(21) Appl. No.: 18/430,818

(22) Filed: Feb. 2, 2024

(51) Int. Cl. G06N 20/00

(52) U.S. Cl. CPC G06N 20/00

(57) ABSTRACT

An example method includes receiving, via a network interface, data relating to a user and a processing pipeline relating to obtaining a first item; determining a current state of the user in the processing pipeline; inputting the received data and the current state into a machine learning model that is trained to receive such inputs for a particular user and generate an output specifying a propensity that the particular user will obtain a particular item; in response to inputting the received data and current state, obtaining, from the machine learning model, a model output specifying a propensity that the user will obtain the first item; and performing, based on the propensity that the user will obtain the first item, a corrective action that mitigates for risks of changing conditions and corresponding impact on an electronic platform when the user obtains the first item.

### TECHNICAL FIELD

The present disclosure relates to computer-implemented methods, software, and systems for using a machine learning model and numerous data points at any point during a processing pipeline to predict a propensity to obtain an item or service on a computing platform and take corrective action on the computing platform in response to the same.

### BACKGROUND

An institution or computing platform can offer various items or services to users. A prospective user can approach the institution/platform to obtain an item or a service and provide, as part of the process to obtain the item, information corresponding to the user and information regarding the particular type of item to be obtained. In some instance, while the institution/platform can commit to providing the item/service, the time horizon over which the item/service is to be provided can be relatively long (e.g., 90 or 120 days). As such, conditions can change between the time that the institution/platform commits to providing the item/service and the time when the item/service is actually received/obtained.

### SUMMARY

The present disclosure generally relates to systems, software, and computer-implemented methods for using a machine learning model and numerous data points at any point during a processing pipeline to predict a propensity to obtain an item or service on a computing platform and take corrective action on the computing platform in response to the same.

A first example method includes receiving, via a network interface, data relating to a user and a processing pipeline relating to obtaining a first item. A current state of the user in the processing pipeline can be determined. The received data and the current state can be input into a machine learning model that is trained to receive such inputs for a particular user and generate an output specifying a propensity that the particular user will obtain a particular item. In response to inputting the received data and current state, obtaining, from the machine learning model, a model output specifying a propensity that the user will obtain the first item can be obtained from the machine learning model. Based on the propensity that the user will obtain the first item, a corrective action that mitigates for risks of changing conditions and corresponding impact on an electronic platform when the user obtains the first item can be performed.

Implementations can optionally include one or more of the following features.

In some implementations, the method can also include determining, from external data, one or more changing conditions, wherein the changing conditions are interest rates regarding the particular item.

In some implementations, the method can also include, based on the changing conditions, an impact on the electronic platform from the user obtaining the first item at a later point in time. In some examples, the corrective action comprises implementing a platform response strategy that offsets detrimental impacts of changing conditions on an electronic platform.

In some implementations, the method can also include training the machine learning model, wherein during the training of the model, multiple sets of data are selected using a feature selection process. The feature selection process can include receiving a set of features, generating a condensed subset of features from the set of features, ranking the features in the condensed subset of features from most predictive to least predictive, training the model by recursively selecting features from the condensed subset of features until the performance of the model reaches a predetermined threshold; removing corelated features from the condensed set of features to obtain an updated set of features, and removing unstable features from the updated set of features to obtain a finalized set of features for training the model.

In some implementations, training data for the predictive machine learning model includes multiple sets of data relating to multiple users and items that users have requested to obtain, and labels in the corresponding set of labels specifying whether the items were obtained along with where the respective user was in in the processing pipeline.

In some implementations, removing unstable features from the updated set of features comprises, for each batch in a plurality of batches, computing model contributions for each feature in the condensed set of features using shapley values and ranking the top features using the model contributions.

In some implementations, the method also includes determining accuracy of the machine learning model at predetermined time intervals; and triggering a re-training of the model in response to determining that the accuracy does not satisfy a predetermined threshold. In some examples, determining accuracy of the predictive machine learning model at predetermined time intervals comprises computing a Brier score at predetermined time intervals and comparing the Brier score to a predetermined threshold.

In some implementations, the method also includes training the machine learning model, wherein during the training of the model, hyperparameters for the predictive machine learning model are determined using a hyperparameter tuning process comprising: iteratively predicting the next hyperparameter set to test that has a highest likelihood of improving the performance of the machine learning model. In some examples, iteratively predicting the next hyperparameter set to test that has the highest likelihood of improving the performance of the machine learning model comprises performing a Bayesian optimization process.

In some implementations, the machine learning model implements a gradient boosting algorithm.

Similar operations and processes associated with each example system may be performed in a different systems comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. Additionally, similar operations can be associated with or provided as computer-implemented software embodied on tangible, non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

The techniques described herein can be implemented to achieve the following advantages. For example, the techniques described herein utilize a machine learning-based techniques to predict a propensity that a user obtains a particular item/service and to enhance corrective action decisions due to long time horizons between the commitment to provide and ultimate acquisition of the item/service. Unlike conventional solutions that utilize numerous computing resources to generate predictions based on aggregated items and provide aggregate corrective actions, the techniques described herein achieve relative computation efficiencies by generating predictions based on individual items and individual corrective actions at any point during a processing pipeline (e.g., the processing period between commitment to provide and ultimate acquisition of the item/service), which leads to more accurate corrective action ratios and less slippage and volatility (relative to conventional solutions). Aggregated items model a pipeline as a single step and do not account for individual positions in the pipeline that may affect the propensity of obtaining the item/service. In some examples, aggregate corrective actions are determined based on averages of multiple user's propensity to obtain an item, rather than for accounting for individual users' propensities. The latter results in more accurate and finetuned predictions that are actionable and allow for implementing a corrective action strategy that is more finetuned based on the position within the processing pipeline. Additionally, generating predictions based on individual items allows the model to account for circumstances that may be unique to an individual and make more accurate propensity estimations.

As another example, the techniques described herein implement resource efficient techniques to utilize scores (e.g., shapley values) for model features corresponding to the deployed machine learning model. In general, computing shapley values for all the model's features can be a computing resource intensive task. In contrast, the techniques described herein utilize historical data as well as localized data to identify those features that have a high contribution (or are expected to have a high contribution) to the model's output. In this manner, the hundreds of features of a model can be reduced to a smaller subset, e.g., of twenty features. The reduced feature set can be further refined by applying a correlation analysis that identifies similar features and in doing so, further reduces the feature set (e.g., to a set of 9-10 features). In this manner, the computation of shapley values in the present solution is performed with respect to a substantially reduced feature set instead of a larger population of features-without any substantive impact on the solution's overall accuracy.

As yet another example, the techniques described herein can use Bayesian optimization to determine the hyperparameters for the machine-learning model while training. Bayesian optimization works by building a probability model of the objective function of a gradient boosting algorithm, and then using it to probabilistically select the next set of hyperparameters with which to evaluate the true objective function. Specifically, for each iteration, the training system can choose the parameter combination that is expected to improve the objective score the most and update the probability model again based on the new result. In contrast to other common hyperparameter tuning methods like grid search and random search, Bayesian optimization can yield a better performing result in far fewer iterations as successive iterations are dependent on previous iterations. Random search and grid search may find an optimal result at any point during the tuning process and all iterations are independent from one another. In contrast, Bayesian optimization can improve the objective score over the iterations.

Further still, the machine-learning based techniques described herein generate propensity predictions to enhance corrective action decisions-regardless of where the user is in the processing pipeline (e.g., at an initial information request stage, at an application submission stage, after approval has been received, etc.). In this manner, the model's output is dynamic and actionable at any point in the item/service acquisition lifecycle e.g., even at an initial information request phase—where the amount of information and data available to make a decision is relatively less than that which may be available at a later stage in the item or service acquisition lifecycle.

### DESCRIPTION OF DRAWINGS

FIG. 1 is a block diagram of an example networked environment for using a machine learning model and numerous data points at any point during a processing pipeline to predict a user's propensity to obtain an item.

FIG. 2 illustrates an example of a propensity determination engine that is configured to identify a propensity that a particular user will obtain an item and a corrective action that mitigates risks for changing conditions and the corresponding impact on an electronic platform when the user obtains the item in a networked environment, such as the networked environment 100.

FIG. 3 is a flow diagram of an example method for identifying a propensity that a particular user will obtain an item and a corrective action.

FIG. 4 is a flow diagram of an example method for training a predictive machine learning model to identify a propensity that a particular user will obtain an item.

### DETAILED DESCRIPTION

The present disclosure describes various tools and techniques associated with using a machine learning model and numerous data points at any point during a processing pipeline to predict a user's propensity to obtain an item and take corrective action on the computing platform in response to the same.

A computing platform can provide items/services and the time horizon to obtain the service or item. The time horizon can be long, as it can be informed by a processing pipeline in which various events may need to occur before the item is provided relative to a quick acquisition (e.g., click and acquire). As a result of the long time horizon, there can be intervening changes that may happen during that time horizon pipeline.

Conventional systems-particularly those that are applied in the context of items/services that are provided over a particular timeline and after processing via a particular processing pipeline-generally employ an aggregate approach to determining a corrective action. Such systems may analyze the processing pipeline as a whole and use blanket corrective actions to make corrective action decisions. However, the aggregate approach suffers from multiple deficiencies. The aggregate approach analyzes the processing pipeline as a single step and does not account for different stages in the pipeline. The aggregate approach uses corrective actions that are based on averages for all possible users. This approach does not take individual characteristics into account and thus, precludes a more granular corrective action strategy (e.g., informed by the points in the pipeline). This approach may waste computing and network resources on generating predictions based on aggregated items and aggregate corrective actions that do not accurately predict the propensity of a user obtaining an item.

In contrast, the techniques described herein enable increased computational and network resource efficiency by generating predictions based on individual items/services and individual corrective actions at any point during the processing pipeline, which leads to more accurate hedging ratios and less slippage and volatility (relative to conventional solutions).

At a high level, the techniques described here uses a predictive machine learning models to predict a propensity that a user will obtain a particular item/service. The propensity can be used to determine a corrective action to be performed. The corrective action can mitigate for risks of changing conditions and corresponding impact on an electronic platform when the user obtains the item.

Additionally, the above-described propensity determination system implements resource efficient techniques to utilize scores (e.g., shapley values) for model features corresponding to the deployed machine learning model. In general, computing shapley values for all the model's features can be a computing resource intensive task. In contrast, the techniques described herein utilize historical data o identify those features that have a high contribution (or are expected to have a high contribution) to the model's output. In this manner, the hundreds of features of a model can be reduced to a smaller subset, e.g., of twenty features. The reduced feature set can be further refined by applying a correlation analysis that identifies similar features and in doing so, further reduces the feature set (e.g., to a set of 9-10 features). In this manner, the computation of shapley values in the present solution is performed with respect to a substantially reduced feature set instead of a larger population of features-without any substantive impact on the solution's overall accuracy.

Further still, the machine-learning based techniques described herein generate propensity predictions to enhance corrective action decisions-regardless of where the user is in the processing pipeline (e.g., at an initial information request stage, at an application submission stage, after approval has been received, etc.). In this manner, the model's output is dynamic and actionable at any point in the product acquisition lifecycle—e.g., even at an initial information request phase—where the amount of information and data available to make a decision is relatively less than that which may be available at a later stage in the product acquisition lifecycle. As the use progresses along the pipeline, the user may be required to provide more information when progressing to the next stage in the pipeline that can be used to make predictions.

The techniques described herein can be used in the context of propensity modelling for any product, item, or service (e.g., financial products, ecommerce products, etc.) and in particular, enable accurate determination of a corrective action strategy. For example, a corrective action can be adjusting attributes related to an item on a platform (e.g., pricing, availability, etc.). One skilled in the art will appreciate that the above described techniques can be applicable in the context of any product, item, or service (irrespective of type of product, item, or service).

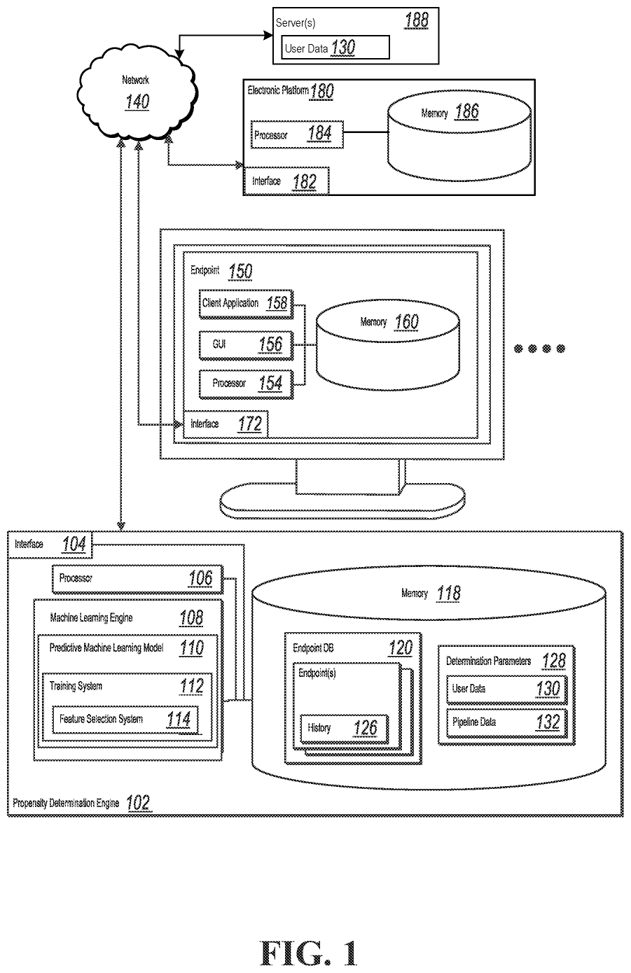

Turning to the illustrated example implementation, FIG. 1 is a block diagram illustrating an example networked environment 100 that uses a machine learning model and numerous data points at any point during a processing pipeline to predict a user's propensity to obtain an item. As further described with reference to FIG. 1, the environment implements a trained machine learning model that is used to analyze user data to perform a corrective action that mitigates for risks of changing conditions and corresponding impact on an electronic platform when the user obtains the item.

As shown in FIG. 1, the example environment 100 includes a propensity determination engine 102, multiple endpoints 150, an electronic platform 180, and multiple servers 188 that are interconnected via a network 140. The function and operation of each of these components is described below.

In some implementations, the illustrated implementation is directed to techniques whereby the propensity determination engine 102 can identify a propensity that a particular user will obtain an item/service and a corrective action that accounts for changing conditions and the corresponding impact on an electronic platform when the user obtains the item/service. The propensity determination engine 102 can compute, using a predictive machine learning model 110 included in a machine learning engine 108, the propensity that a particular user associated with a particular endpoint 150 will obtain the item/service. The machine learning engine 108 may be any application, program, other component, or combination thereof that, when executed by the processor 106, enables calculation of a likelihood that a user will obtain an item/service. The training system 112 can train the predictive machine learning model 110 to process data relating to multiple users seeking to obtain items/services and data relating to processing pipelines relating to the items/services that these user are seeking to obtain. The training system 112 can include a feature selection system that can determine a subset of contributing features for the user that are indicative of a likelihood of the user obtaining a particular item/service.

As described above, and in general, the environment 100 enables the illustrated components to share and communicate information across devices and systems (e.g. propensity determination engine 102, endpoint 150, electronic platform 180, server 188, among others) via network 140. As described herein, the propensity determination engine 102 and/or the endpoint 150 may be cloud-based components or systems (e.g., partially or fully), while in other instances, non-cloud-based systems may be used. In some instances, non-cloud-based systems, such as on-premise systems, client-server applications, and applications running on one or more client devices, as well as combinations thereof, may use or adapt the processes described herein. Although components are shown individually, in some implementations, functionality of two or more components, systems, or servers may be provided by a single component, system, or server. Conversely, functionality that is shown or described as being performed by one component, may be performed and/or provided by two or more components, systems, or servers.

As used in the present disclosure, the term “computer” is intended to encompass any suitable processing device. For example, the propensity determination engine 102, and/or the endpoint 150 may be any computer or processing devices such as, for example, a blade server, general-purpose personal computer (PC), Mac®, workstation, UNIX-based workstation, or any other suitable device. Moreover, although FIG. 1 illustrates a single propensity determination engine 102, the propensity determination engine 102 can be implemented using a single system or more than those illustrated, as well as computers other than servers, including a server pool. In other words, the present disclosure contemplates computers other than general-purpose computers, as well as computers without conventional operating systems.

Similarly, the endpoint 150 may be any system that can request data and/or interact with the propensity determination engine 102. The endpoint 150, also referred to herein as client device 150, in some instances, may be a desktop system, a client terminal, or any other suitable device, including a mobile device, such as a smartphone, tablet, smartwatch, or any other mobile computing device. In general, each illustrated component may be adapted to execute any suitable operating system, including Linux, UNIX, Windows, Mac OS®, Java™, Android™, Windows Phone OS, or iOS™, among others. The endpoint 150 may include one or more platform-specific (e.g., financial institution-specific) applications executing on the endpoint 150, or the endpoint 150 may include one or more Web browsers or web applications that can interact with particular applications executing remotely from the endpoint 150, such as the machine learning engine 108, among others.

As illustrated, the propensity determination engine 102 includes or is associated with interface 104, processor(s) 106, machine learning engine 108, and memory 118. While illustrated as provided by or included in the propensity determination engine 102, parts of the illustrated components/functionality of the propensity determination engine 102 may be separate or remote from the propensity determination engine 102, or the propensity determination engine 102 may itself be distributed across the network 140.

The interface 104 of the propensity determination engine 102 is used by the propensity determination engine 102 for communicating with other systems in a distributed environment—including within the environment 100—connected to the network 140, e.g., the endpoint 150, and other systems communicably coupled to the illustrated campaign selection engine 102 and/or network 140. Generally, the interface 104 comprises logic encoded in software and/or hardware in a suitable combination and operable to communicate with the network 140 and other components. More specifically, the interface 104 can comprise software supporting one or more communication protocols associated with communications such that the network 140 and/or interface's hardware is operable to communicate physical signals within and outside of the illustrated environment 100. Still further, the interface 104 can allow the propensity determination engine 102 to communicate with the endpoint 150, and/or other portions illustrated within the propensity determination engine 102 to perform the operations described herein.

The propensity determination engine 102, as illustrated, includes one or more processors 106. Although illustrated as a single processor 106 in FIG. 1, multiple processors may be used according to particular needs, desires, or particular implementations of the environment 100. Each processor 106 may be a central processing unit (CPU), an application specific integrated circuit (ASIC), a field-programmable gate array (FPGA), or another suitable component. Generally, the processor 106 executes instructions and manipulates data to perform the operations of the propensity determination engine 102. Specifically, the processor 106 executes the algorithms and operations described in the illustrated figures, as well as the various software modules and functionality, including the functionality for sending communications to and receiving transmissions from the endpoint 150, as well as to other devices and systems. Each processor 106 may have a single or multiple core, with each core available to host and execute an individual processing thread. Further, the number of, types of, and particular processors 106 used to execute the operations described herein may be dynamically determined based on a number of requests, interactions, and operations associated with the propensity determination engine 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including, e.g., C, C++, JavaScript, Java™, Visual Basic, assembler, Perl®, any suitable version of 4GL, as well as others.

The propensity determination engine 102 can include, among other components, one or more applications, entities, programs, agents, or other software or similar components configured to perform the operations described herein.

The propensity determination engine 102 also includes memory 118, which may represent a single memory or multiple memories. The memory 118 may include any memory or database module and may take the form of volatile or non-volatile memory including, without limitation, magnetic media, optical media, random access memory (RAM), read-only memory (ROM), removable media, or any other suitable local or remote memory component. The memory 118 may store various objects or data associated with propensity determination engine 102, including any parameters, variables, algorithms, instructions, rules, constraints, or references thereto. While illustrated within the propensity determination engine 102, memory 118 or any portion thereof, including some or all of the particular illustrated components, may be located remote from the propensity determination engine 102 in some instances, including as a cloud application or repository, or as a separate cloud application or repository when the campaign selection engine 102 itself is a cloud-based system. As illustrated, memory 118 includes an endpoint database 120. The endpoint database 120 can store various data associated with endpoint(s), including each endpoint's history 126. The history 126 of an endpoint can include, among other things, previously computed likelihoods for the particular endpoint.

Electronic platform 180 is a platform that implements the operations associated with the propensity determination engine 102. The electronic platform 180 interacts with third party servers 188 to obtain information that can be used during inference and training of the predictive machine learning model 110. The information can include data 130 that relates to users and data related to processing pipeline for obtaining items/services. As illustrated, the electronic platform 180 may include an interface 182 for communication (which may be operationally and/or structurally similar to interface 104), at least one processor 184 (which may be operationally and/or structurally similar to processor 106), and a memory 160 (similar to or different from memory 118).

Network 140 facilitates wireless or wireline communications between the components of the environment 100 (e.g., between the propensity determination engine 102, the endpoint 150, the electronic platform 180, and the servers 188, etc.), as well as with any other local or remote computers, such as additional mobile devices, clients, servers, or other devices communicably coupled to network 140, including those not illustrated in FIG. 1. In the illustrated environment, the network 140 is depicted as a single network, but may be comprised of more than one network without departing from the scope of this disclosure, so long as at least a portion of the network 140 may facilitate communications between senders and recipients. In some instances, one or more of the illustrated components (e.g., the propensity determination engine 102, the endpoint 150, the electronic platform 180, the servers 188 etc.) may be included within or deployed to network 140 or a portion thereof as one or more cloud-based services or operations. The network 140 may be all or a portion of an enterprise or secured network, while in another instance, at least a portion of the network 140 may represent a connection to the Internet. In some instances, a portion of the network 140 may be a virtual private network (VPN). Further, all or a portion of the network 140 can comprise either a wireline or wireless link. Example wireless links may include 802.11a/b/g/n/ac, 802.20, WiMax, LTE, and/or any other appropriate wireless link. In other words, the network 140 encompasses any internal or external network, networks, sub-network, or combination thereof operable to facilitate communications between various computing components inside and outside the illustrated environment 100. The network 140 may communicate, for example, Internet Protocol (IP) packets, Frame Relay frames, Asynchronous Transfer Mode (ATM) cells, voice, video, data, and other suitable information between network addresses. The network 140 may also include one or more local area networks (LANs), radio access networks (RANs), metropolitan area networks (MANs), wide area networks (WANs), all or a portion of the Internet, and/or any other communication system or systems at one or more locations.

As illustrated, one or more endpoints 150 may be present in the example environment 100. Although FIG. 1 illustrates a single endpoint 150, multiple endpoints may be deployed and in use according to the particular needs, desires, or particular implementations of the environment 100. Each endpoint 150 may be associated with a particular user (e.g., an employee or a customer of a financial institution), or may be accessed by multiple users, where a particular user is associated with a current session or interaction at the endpoint 150. Endpoint 150 may be a client device at which the user is linked or associated, or a client device through which the user interacts with campaign propensity determination engine 102 and its machine learning engine 108. As illustrated, the endpoint 150 may include an interface 152 for communication (which may be operationally and/or structurally similar to interface 104), at least one processor 154 (which may be operationally and/or structurally similar to processor 106), a graphical user interface (GUI) 156, a client application 158, and a memory 160 (similar to or different from memory 118) storing information associated with the endpoint 150.

The illustrated endpoint 150 is intended to encompass any computing device such as a desktop computer, laptop/notebook computer, mobile device, smartphone, personal data assistant (PDA), tablet computing device, one or more processors within these devices, or any other suitable processing device. In general, the endpoint 150 and its components may be adapted to execute any operating system. In some instances, the endpoint 150 may be a computer that includes an input device, such as a keypad, touch screen, or other device(s) that can interact with one or more client applications, such as one or more mobile applications, including for example a web browser, a banking application, or other suitable applications, and an output device that conveys information associated with the operation of the applications and their application windows to the user of the endpoint 150. Such information may include digital data, visual information, or a GUI 156, as shown with respect to the endpoint 150. Specifically, the endpoint 150 may be any computing device operable to communicate with the propensity determination engine 102, other end point(s), and/or other components via network 140, as well as with the network 140 itself, using a wireline or wireless connection. In general, the endpoint 150 comprises an electronic computer device operable to receive, transmit, process, and store any appropriate data associated with the environment 100 of FIG. 1.

The client application 158 executing on the endpoint 150 may include any suitable application, program, mobile app, or other component. Client application 158 can interact with the propensity determination engine 102, or portions thereof, via network 140. In some instances, the client application 158 can be a web browser, where the functionality of the client application 158 can be realized using a web application or website that the user can access and interact with via the client application 158. In other instances, the client application 158 can be a remote agent, component, or a dedicated application associated with the campaign selection engine 102. In some instances, the client application 158 can interact directly or indirectly (e.g., via a proxy server or device) with the campaign selection engine 102 or portions thereof.

GUI 156 of the endpoint 150 interfaces with at least a portion of the environment 100 for any suitable purpose, including generating a visual representation of any particular client application 158 and/or the content associated with any components of the propensity determination engine 102. For example, the GUI 156 can be used to present screens and information associated with the machine learning engine 108 and interactions associated therewith. GUI 156 may also be used to view and interact with various web pages, applications, and web services located local or external to the endpoint 150. Generally, the GUI 156 provides the user with an efficient and user-friendly presentation of data provided by or communicated within the system. The GUI 156 may comprise a plurality of customizable frames or views having interactive fields, pull-down lists, and buttons operated by the user. In general, the GUI 156 is often configurable, supports a combination of tables and graphs (bar, line, pie, status dials, etc.), and is able to build real-time portals, application windows, and presentations. Therefore, the GUI 156 contemplates any suitable graphical user interface, such as a combination of a generic web browser, a web-enable application, intelligent engine, and command line interface (CLI) that processes information in the platform and efficiently presents the results to the user visually.

While portions of the elements illustrated in FIG. 1 are shown as individual components that implement the various features and functionality through various objects, methods, or other processes, the software may instead include a number of sub-components, third-party services, libraries, and such, as appropriate. Conversely, the features and functionality of various components can be combined into single components as appropriate.

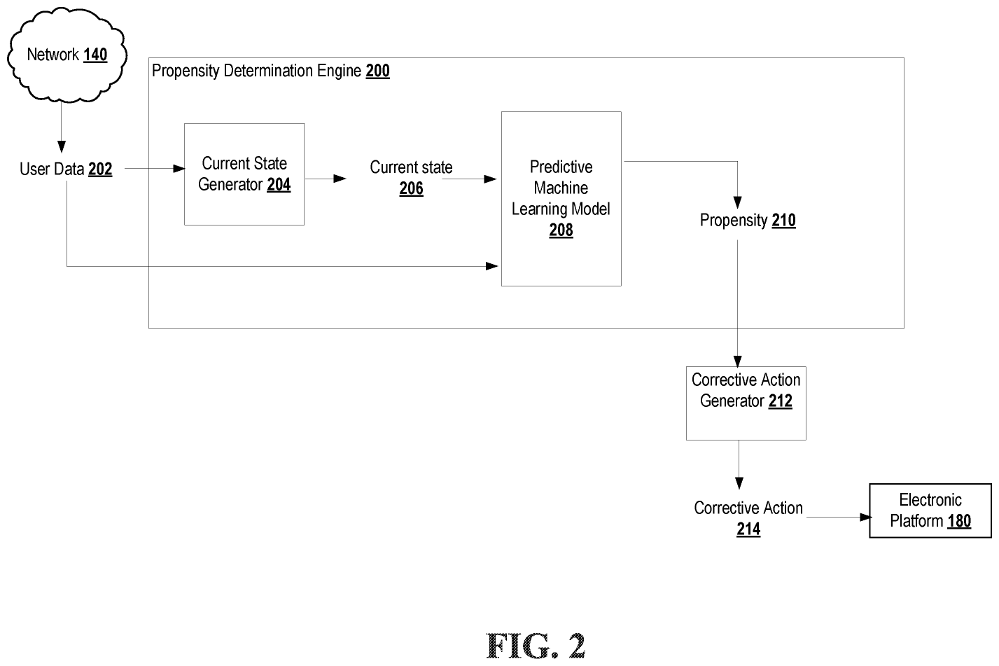

FIG. 2 shows an example of a propensity determination engine 200 that is configured to identify a propensity that a particular user will obtain an item/service and a corrective action generator 212 that is configured to identify a corrective action that accounts for changing conditions and the corresponding impact on an electronic platform when the user obtains the item/service in a networked environment, such as the networked environment 100.

As illustrated in FIG. 2, the propensity determination engine 200 includes a current state generator 204 and a predictive machine learning model 208.

The current state generator 204 receives user data 202 from the network 140 and processes the user data to generate a current state 206 of a user in a processing pipeline.

The user data 202 is data that relates to a user and a processing pipeline relating to obtaining an item/service. The user data can represent attributes corresponding to a user and the particular item/service that the customer is trying to obtain. Examples of user data include, e.g., application data, customer demographic data, channel interaction data, and location data.

The processing pipeline can be any processing pipeline that tracks users as they progress through different stages of obtaining an item/service. The user data 202 can be obtained at any point during a processing pipeline, including, e.g., (1) a point in the pipeline when the user makes an initial request for a particular item/service, (2) a point in the pipeline when the user has submitted an official application requesting the particular item/service. The user data can include, for example, where in the processing pipeline the user is with respect to obtaining the item/service, the status of the user in the pipeline, etc. For example, the particular item/service can be a mortgage application with a particular interest rate commitment. The current state 206 indicates the point in the processing pipeline that the user is at during a particular point in time.

The predictive machine learning model 208 processes the user data 202 and the current state 206 to generate a model output that specifies a propensity 210 that a user will obtain a particular item/service.

The predictive machine learning model 208 can be any appropriate type of machine learning model that can be configured to process user data/attributes and a current state for a particular user and generate an output specifying a propensity that the particular user will obtain a particular item/service e.g., a gradient boosting model. For example, the predictive machine learning model 208 can implement an Extreme Gradient Boosting algorithm (XGBoost), to leverage the scalability and high accuracy of a gradient boosted tree-based learning algorithm. The predictive machine learning model 208 model can be trained as a classifier based on historical user data and the binary target variable of whether a user obtained an individual item/service within a specified time period (e.g., a 120-day window).

The predictive machine learning model 208 can use XGBoost due to its speed, efficiency, scalability, and accuracy. XGBoost is an ensemble method, which improves upon traditional decision tree models by using multiple trees to help correct errors of previous trees (a process known as boosting).

XGBoost is used for the binary classification at issue here because it can efficiently handle large data sets with a mix of data types including categorical and numeric features. Furthermore, implementations of SHAP analysis (i.e., which compute shapley values) exist for XGBoost models, allowing for local and global explainability of the model behavior that can be used by model developers as well as the end-users of the model to further refine or understand the results of the model.

There are numerous advantages of using a gradient boosting algorithm for this model, including the improved model explainability of boosted tree methods compared to neural networks. Traditional decision trees are prone to overfitting and are unlikely to achieve the same performance as a gradient boosted method.

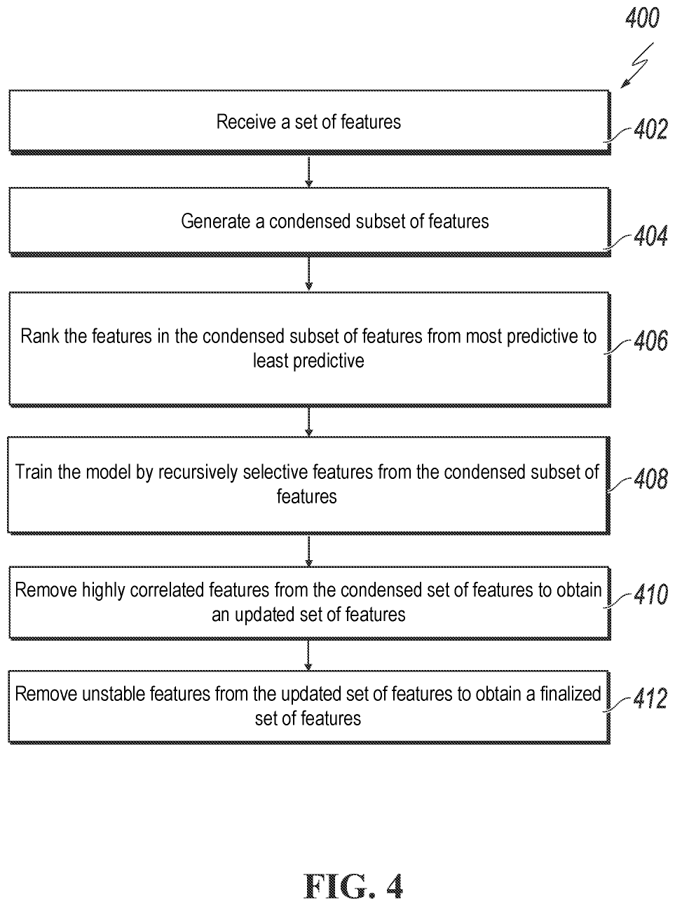

The predictive machine learning model's primary task is to predict the likelihood of a user obtaining an individual item/service within a specified time period. To train the model, historical snapshots of users and items/services from application data are used. These snapshots are processed through a SQL-based pipeline, which filters and retains only those snapshots corresponding to significant characteristic changes. Additionally, the SQL pipeline can generate flags that provide valuable insights into the nature of these characteristic changes. Training the predictive machine learning model 208 will be described in more detail below with reference to FIG. 4.

The model output includes a propensity 210 that indicated the likelihood that the user will obtain the particular item/service. The likelihood can be a percentage (e.g., 0.4, 0.6) or a binary value (e.g., 0 or 1).

The corrective action generator 212 processes the propensity 210 that the user will obtain the particular item/service and determine a corrective action 214 that mitigates for risks of changing conditions and corresponding impact on an electronic platform 218 when the user obtains the particular item/service.

The corrective action 214 can include implementing a platform response strategy that offsets detrimental impacts of changing conditions on an electronic platform. The corrective action can, for example, be adjusting attributes related to an item on a platform (e.g., pricing, availability, etc.). As another example, the corrective action can be adjusting hedging ratios to account for mortgage commitments. The corrective action generator 214 can determine one or more changing conditions from external data. The changing conditions can be, for example, interest rates regarding the particular item/service. The corrective action generator 212 can determine, based on the changing conditions, an impact on the electronic platform from the user obtaining the first item/service at a later point in time.

The corrective action generator 212 can combine the propensity 210 with specific metadata to increase model explainability and aid in interpreting and understanding the output of the predictive machine learning model 208. The metadata can, for example, include a flag indicating that the type of item has changed, the date that the item is obtained, etc. (among other types of metadata that can be appended to the propensity 210 to achieve improved model explainability).

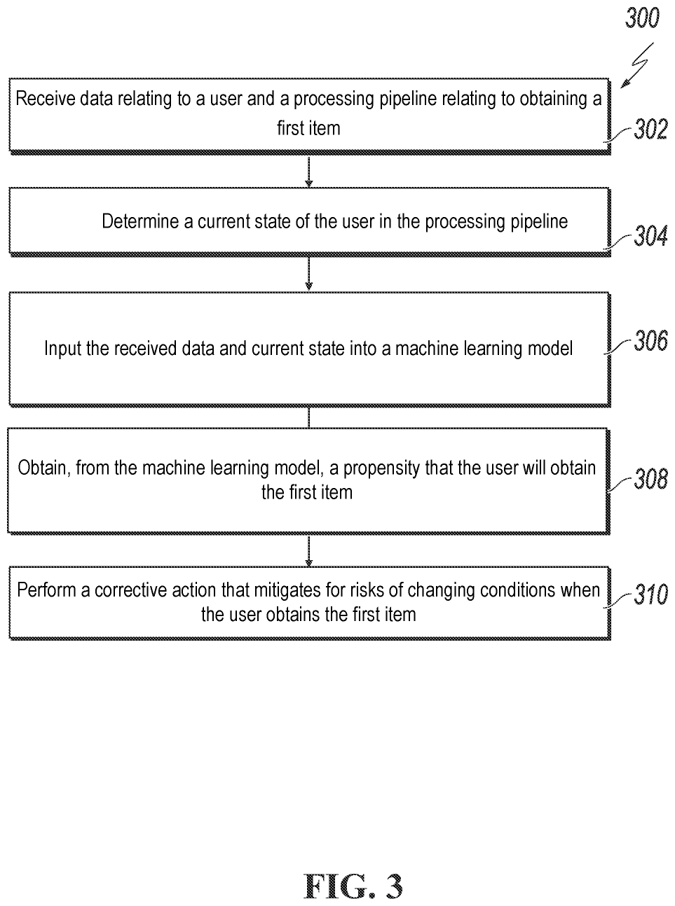

FIG. 3 is a flow diagram of an example method 300 for identifying a propensity that a particular user will obtain an item/service and a corrective action in a networked environment in a networked environment, such as the networked environment 100. Method 300 may be performed, for example, by any suitable system, environment, software, and hardware, or a combination of systems, environments, software, and hardware as appropriate. In some instances, method 300 can be performed by one or more components of the environment 100, including, among others, the propensity determination engine 102, or portions thereof, described in FIG. 1, as well as other components or functionality described in other portions of this description. In other instances, the method 300 can be performed by a plurality of connected components or systems, such as those illustrated in FIG. 2. Any suitable system(s), architecture(s), or application(s) can be used to perform the illustrated operations.

At 302, the propensity determination engine 102 receives, via a network interface, data relating to a user and a processing pipeline relating to obtaining a first item/service.

The data relating to a user and a processing pipeline relating to obtaining an item/service can represent attributes corresponding to a user and the particular item/service that the user is trying to obtain. Examples of user data include, e.g., application data (e.g., application status, type of item/service that the user is applying for, etc.), customer demographic data (e.g., age, income, etc.), channel interaction data (e.g., changes in the application), and location data (e.g., stage of the user's application in the pipeline). The processing pipeline can be any processing pipeline that tracks users as they progress through different stages of obtaining an item/service. For example, the processing pipeline can be a fixed rate mortgage commitment pipeline.

At 304, the propensity determination engine 102 determines a current state of the user in the processing pipeline. The current state can indicate the point in the processing pipeline that the user is at during a particular point in time. For example, the propensity determination engine can process the data relating the user and the propensity pipeline to determine that the user is at an initial information request stage in the pipeline.

At 306, the propensity determination engine 102 inputs the received data and current state into a machine learning model. The machine learning model is trained to receive such inputs for a particular user and generate an output specifying a propensity that the particular user will obtain a particular item/service.

At 308, the propensity determination engine 102, in response to inputting the received data and current state, obtains, from the machine learning model, a model output. The model output specifies a propensity that the user will obtain the first item/service.

At 310, the propensity determination engine 102 performs, based on the propensity that the user will obtain the first item/service, a corrective action. The corrective action mitigates for risks of changing conditions and corresponding impact on an electronic platform when the user obtains the first item/service. The corrective action can include implementing a platform response strategy that offsets detrimental impacts of changing conditions on an electronic platform.

In some implementations, the propensity determination engine 102, determines, from external data, one or more changing conditions. The changing conditions can be, for example, interest rates regarding the particular item/service.

In some implementations, the propensity determination engine 102, determines, based on the changing conditions, an impact on the electronic platform from the user obtaining the first item/service at a later point in time.

FIG. 4 is a flow diagram of an example method 400 for training a predictive machine learning model to identify a propensity that a particular user will obtain an item/service. It should be understood that method 400 may be performed, for example, by any suitable system, environment, software, and hardware, or a combination of systems, environments, software, and hardware as appropriate. Any suitable system(s), architecture(s), or application(s) can be used to perform the illustrated operations. For convenience, the process 400 will be described as being performed by a training system.

At 402, the training system receives a set of features. The features can be features representing attributes corresponding to a first user in a processing pipeline relating to a particular item/service that the user is trying to obtain. Example features include, item history (e.g., if a characteristic of the item has changed, the number of changes in the value of the item, etc.), user history (e.g., number of inquiries regarding an item, attributes of the item, number of declined applications for the item, etc.), and user demographics (e.g., user income, user age, user location, payment history etc.).

At 404, the training system generates a condensed subset of features from the set of features. The training system can perform a preliminary screening where the features with no information due to missingness, perfect correlation, or erroneous values are removed from the set of features. The training system can determine that no information is present when a value has not been populated. The training system can calculate a Spearman's rank correlation coefficient for numerical variables or a Cramer's V association coefficient for categorical variables. A perfect correlation is indicated by a Spearman's rank correlation coefficient or a Cramer's V association coefficient of 1. The training system can perform a data cleaning process to eliminate erroneous values that are determined to have no meaning or to fall outside of a predetermined range.

Spearman's rank correlation is a non-parametric measure of correlation between two variables. The Spearman's rank correlation coefficient returns a value ranging from −1 to 0 to +1, where 0 is no relationship and +1, and −1 is a perfect relationship. The following is the definition of Spearman's rank correlation coefficient:

$$ρ = 1 - \frac{6 \sum difference between the ranks for each {pair}^{2}}{n ( {n}^{2} - 1 )}$$

Cramer's V is used to measure the strength and association between two categorical variables in a contingency table. It quantifies the degree of association between categorical variables while accounting for the table's dimensions. The Cramer's V values range from 0 to 1, where 0 indicates no association and a value close to 1 indicates a strong association.

At 406, the training system ranks the features in the condensed subset of features from most predictive to least predictive. The training system can first train a separate machine learning model for each individual feature (with only one feature in each model) to make a propensity prediction. Each separate machine learning model can be a simple model with hyperparameters designed so that the model is shallow and simple to train in order to save computing resources. For example, a hyperparameter can be set so that the model performs gradient boosting over a small number (e.g., 10, 20, etc.) of iterations. As another example, a hyperparameter can be set so that the model uses all data and doesn't perform any subsampling. The training system can determine the individual predictive power of each feature by evaluating the performance of each feature's respective machine learning model and then rank all received features by their individual predictive power.

The predictive power can be a measure of accuracy. For example, the predictive power can measure an Area under the receiver operating characteristic curve (ROC-AUC), Kolmogorov-Smirnov test statistics (K-S Statistics), Mean Squared Error between prediction score and true target (Brier Score), Expectation Calibration Error (ECE), and/or any other metrics that asses the accuracy and separability of probability scores. Because the model is not used for binary classification of instances based on a certain threshold, many common threshold-based evaluation metrics like recall, precision, F1, etc. are not applicable. Instead, the training system uses metrics that are independent of thresholds to assess the goodness of predicted scores in multiple ways. Specifically, ROC-AUC is used to evaluate the overall rank separability of the predicted scores. The K-S statistic shows how distinct the distributions of scores are for positive and negative classes overall. Brier score directly measures the accuracy of probabilistic predictions by calculating the mean squared deviations of the predicted probabilities from the target labels. In addition, to ensure the predicted scores can be used and interpreted as probabilities that a user will obtain an item/service, the training system can calculate expected calibration error to check if the probabilities are well-calibrated.

For example, if the condensed subset of features includes 50 features, the training system can train 50 individual machine learning models with each model trained using a different feature from the condensed set of features. The training system can calculate a predictive power (e.g., Brier score) for each model and rank features based on the predictive power associated with the respective machine learning model. At 408, the training system trains the machine learning model by recursively selecting features from the condensed subset of features until the performance of the model reaches a predetermined threshold.

In some implementations, the training data for the predictive machine learning model includes multiple sets of data relating to multiple users and item/services that users have requested to obtain, and labels in the corresponding set of labels specifying whether the items/services were obtained along with where the respective user was in in the processing pipeline. The machine learning model can be trained by optimizing a loss function based on a difference between the model's output during training and the corresponding label.

The training system can select the feature with the highest predictive power as the initial base feature for recursive feature selection. Furthermore, the training system can use the ranking of the features in the condensed subset of features as the order in which to add features during recursive feature selection. In this manner, the hundreds of features of a model can be reduced to a smaller subset, e.g., of twenty features.

In some implementations, the training system determines the accuracy of the machine learning model at predetermined time intervals. The training system can pull performance metrics of the machine learning model at predetermined frequencies i.e., after N training iterations, where N is an integer greater than or equal to 1. The performance metrics can include ROC-AUC to evaluate the overall rank separability of the predicted scores, K-S statistic shows how distinct the distributions of scores are for positive and negative classes overall, and Brier score to directly measure the accuracy of probabilistic predictions The training system can trigger a re-training of the model in response to determining that the accuracy does not satisfy a predetermined threshold. Determining accuracy of the predictive machine learning model at predetermined time intervals can include calculating a Brier score at predetermined time intervals. A Brier score is the means squared error of the model's predicted scores. A Brier score if used as a evaluation metric for binary classification because it provides a comprehensive assessment of a model's probabilistic predictions. A Brier score of 1 indicates all predicted scores are opposite to the target label, while a score of 0 indicates all scores are equal to the corresponding target label.

For example, the training system can recursively test features in groups e.g., in groups of 10 features. For each feature not yet selected in the group, the training system can add them individually to the selected base feature(s) and train a machine learning model for each combination, and then evaluate each model's performance with a Brier score. The training system can consider a feature for addition to the base if it gives an improvement in Brier score above a threshold e.g., 0.0001. For example, a Brier score of 0.0001 would correspond to a gain of 0.01 or 1%.

For example, a group can have 5 features. The training system can train the machine learning model and compute the Brier score for an initial base feature. The training system can then recursively add a feature from the group of 5 features and compute the Brier score for the model after adding the feature. The training system can add that feature to the set of base features if the Brier score surpasses a threshold. If the Brier score does not surpass the threshold, the training system can disregard that feature. The training system can recursively repeat this process that for the rest of the features in the group.

The training system can add the feature that gives the best performance gain within the group to the accumulated base. After a feature from the group is added, the training system can repeat this process for the remaining features in the group. When no features in the group give a gain exceeding the threshold, the training system can move on to the next group of features. Once all groups of features have been tested, the accumulated base of features becomes a candidate set of features.

In some implementations, during the training of the model, the training system can determine hyperparameters for the predictive machine learning model using a hyperparameter tuning process. The training system can iteratively predict the next hyperparameter set to test that has a highest likelihood of improving the performance of the predictive machine learning model.

The training system can use Bayesian optimization to determine the hyperparameters. Bayesian optimization works by building a probability model of the objective function of a gradient boosting algorithm, and then use it to probabilistically select the next set of hyperparameters with which to evaluate the true objective function. Specifically, for each iteration, the training system can choose the parameter combination that is expected to improve the objective score the most and update the probability model again based on the new result. The training system can, for example, select the parameter combination with the lowest Brier score. The probability model is used to identify the combination of hyperparameter values that are most likely to yield an improved objective score and this combination is used in the next iteration. The training system calculates the true objective score and updates the probability model for the next iteration. The probability model can, for example, be a Tree Parzen Estimator (TPE) that builds a model by applying Bayes rule. Instead of directly representing p(y|x), it instead uses:

$$p ( y \vert x ) = \frac{p ( x \vert y ) * p ( y )}{p ( x )} ,$$

where x represents the combination of hyperparameters and y represents the objective score.

In contrast to other common hyperparameter tuning methods like grid search and random search, Bayesian optimization can yield a better performing result in far fewer iterations as successive iterations are dependent on previous iterations. Random search and grid search may find an optimal result at any point during the tuning process and all iterations are independent from one another. In contrast, Bayesian optimization can improve the objective score over the iterations. The objective function can be the same as the objective used for feature selection e.g., Brier score.

The training system can tune hyperparameters after the feature selection process. To take the actual predicted probabilities into account and encourage well-calibrated predictions, the objective function evaluated at each optimization trial is the same as the objective function used for feature selection. In other words, the objective of the Bayesian optimization is to minimize the Brier score of validation data.

At 410, the training system removes correlated features from the candidate set of features to obtain an updated set of features.

The training system can remove similar features from the candidate subset of contributing features and in doing so, further reduces the feature set (e.g., to a set of 9-10 features). The training system can perform a correlation analysis on the candidate subset of contributing features. The correlation analysis can be any process that calculates correlations (e.g., Spearman correlations, Cramer's V correlations, etc.) between feature pairs. In this manner, a predictive machine learning model can process a substantially reduced feature set instead of a larger population of features-without any substantive impact on the solution's overall accuracy.

At 412, the training system removes unstable features from the updated set of features to obtain a finalized set of features for training the model. Stability testing in the feature selection process assesses the consistency of selected features across different subsets of the training data. Stability testing helps determine which features are robust and essential for a given task and identify features that are less likely to be noise, hence enhancing the reliability of the model. The system can rank features on, for example, mean absolute shapley values to determine feature contribution. The training system can determine that the feature contributions are stable over time.

In some implementations, the training system, for each batch in a plurality of batches of training data, computes model contributions for each feature in the condensed set of features using shapley values and ranks the top features using the model contributions. The training system can conduct the stability test by training N (where N is the number of batches e.g., 5) models in N-fold cross-validation using the condensed set of features, and compute feature contribution using Shapley values. The training data can be divided into N batches to account for the inherent temporal element in the processing pipeline, accurately assess performance on unseen data both in-time and out-of-time, allow for differing validations batches, and prevent data leakage in training process.

For example, the training system can divide the set of training data into 5 folds each consisting of a unique set of data. For feature selection and hyperparameter tuning, 4 of the folds can be combined to serve as training data, while the remaining fold can be used for validation. Different validation folds can be used for each of feature selection and hyperparameter tuning so that these processes do not operate on the same data.

The training system can avoid overfitting and underfitting by tuning the key parameters constraining the model structure together. Specifically, for ensembled trees, having a large number of trees with many layers of splits is likely to cause overfitting while a smaller number of shallow trees may cause underfitting. In order to find a balanced model structure and further control overfitting, the training system can restrict the split on a leaf node, add a degree of regularization, and add some random noise for each tree. Additionally, the training system can tune a hyperparameter help to rebalance the dataset by scaling the gradient and potentially improve model performance.

In this manner, using a machine learning model and numerous data points at any point during a processing pipeline to predict a propensity to obtain an item or service on a computing platform and take corrective action on the computing platform in response to the same is described in this specification. The machine learning model processes data relating to a user and a processing pipeline relating to obtaining a first item and a current state of the user in the processing pipeline to obtain a model output specifying a propensity that the user will obtain the first item. The propensity that the user will obtain the first item can be used to determine and perform a corrective action that mitigates for risks of changing conditions and corresponding impact on an electronic platform when the user obtains the first item.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer implemented method comprising:
receiving, via a network interface, data relating to a user and a processing pipeline relating to obtaining a first item;
determining a current state of the user in the processing pipeline;
inputting the received data and the current state into a machine learning model that is trained to receive such inputs for a particular user and generate an output specifying a propensity that the particular user will obtain a particular item;
in response to inputting the received data and the current state, obtaining, from the machine learning model, a model output specifying a propensity that the user will obtain the first item; and
performing, based on the propensity that the user will obtain the first item, a corrective action that mitigates for risks of changing conditions and corresponding impact on an electronic platform when the user obtains the first item.

2. The computer-implemented method of claim 1, further comprising:
determining, from external data, one or more changing conditions, wherein the changing conditions are interest rates regarding the particular item.

3. The computer-implemented method of claim 2, further comprising determining, based on the changing conditions, an impact on the electronic platform from the user obtaining the first item at a later point in time.

4. The computer implemented method of claim 2, wherein the corrective action comprises implementing a platform response strategy that offsets detrimental impacts of changing conditions on an electronic platform.

5. The computer-implemented method of claim 1, further comprising training the machine learning model, wherein during the training of the model, multiple sets of data are selected using a feature selection process comprising:
receiving a set of features;
generating a condensed subset of features from the set of features;
ranking the features in the condensed subset of features from most predictive to least predictive;
training the model by recursively selecting features from the condensed subset of features until the performance of the model reaches a predetermined threshold;
removing correlated features from the condensed set of features to obtain an updated set of features; and
removing unstable features from the updated set of features to obtain a finalized set of features for training the model.

6. The computer-implemented method of claim 1, wherein training data for the predictive machine learning model includes multiple sets of data relating to multiple users and items that users have requested to obtain, and labels in the corresponding set of labels specifying whether the items were obtained along with where the respective user was in in the processing pipeline.

7. The computer implemented method of claim 5, wherein removing unstable features from the updated set of features comprises, for each batch in a plurality of batches:
computing model contributions for each feature in the condensed set of features using shapley values; and
ranking the top features using the model contributions.

8. The computer-implemented method of claim 1, further comprising:
determining accuracy of the machine learning model at predetermined time intervals; and
triggering a re-training of the model in response to determining that the accuracy does not satisfy a predetermined threshold.

9. The computer-implemented method of claim 8, wherein determining accuracy of the predictive machine learning model at predetermined time intervals comprises computing a Brier score at predetermined time intervals and comparing the Brier score to a predetermined threshold.

10. The computer-implemented method of claim 1, further comprising training the machine learning model, wherein during the training of the model, hyperparameters for the predictive machine learning model are determined using a hyperparameter tuning process comprising:
iteratively predicting the next hyperparameter set to test that has a highest likelihood of improving the performance of the machine learning model.

11. The computer-implemented method of claim 10, wherein iteratively predicting the next hyperparameter set to test that has the highest likelihood of improving the performance of the machine learning model comprises performing a Bayesian optimization process.

12. The computer-implemented method of claim 1, wherein the machine learning model implements a gradient boosting algorithm.

13. A system comprising:
at least one memory storing instructions;
a network interface; and
at least one hardware processor interoperably coupled with the at least one memory and the network interface, wherein execution of the instructions by the at least one hardware processor causes performance of operations comprising:
receiving, via the network interface, data relating to a user and a processing pipeline relating to obtaining a first item;
determining a current state of the user in the processing pipeline;
inputting the received data and the current state into a machine learning model that is trained to receive such inputs for a particular user and generate an output specifying a propensity that the particular user will obtain a particular item;
in response to inputting the received data and the current state, obtaining, from the machine learning model, a model output specifying a propensity that the user will obtain the first item; and
performing, based on the propensity that the user will obtain the first item, a corrective action that mitigates for risks of changing conditions and corresponding impact on an electronic platform when the user obtains the first item.

14. The system of claim 13, the operations further comprising:
determining, from external data, one or more changing conditions, wherein the changing conditions are interest rates regarding the particular item.

15. The system of claim 14, the operations further comprising:
determining, based on the changing conditions, an impact on the electronic platform from the user obtaining the first item at a later point in time.

16. The system of claim 14, wherein the corrective action comprises implementing a platform response strategy that offsets detrimental impacts of changing conditions on an electronic platform.

17. A non-transitory, computer-readable medium storing computer-readable instructions, that upon execution by at least one hardware processor, cause performance of operations, comprising:
receiving, via a network interface, data relating to a user and a processing pipeline relating to obtaining a first item;
determining a current state of the user in the processing pipeline;
inputting the received data and the current state into a machine learning model that is trained to receive such inputs for a particular user and generate an output specifying a propensity that the particular user will obtain a particular item;
in response to inputting the received data and the current state, obtaining, from the machine learning model, a model output specifying a propensity that the user will obtain the first item; and
performing, based on the propensity that the user will obtain the first item, a corrective action that mitigates for risks of changing conditions and corresponding impact on an electronic platform when the user obtains the first item.

18. The non-transitory, computer-readable medium of claim 17, the operations further comprising:
determining, from external data, one or more changing conditions, wherein the changing conditions are interest rates regarding the particular item.

19. The non-transitory, computer-readable medium of claim 18, the operations further comprising:
determining, based on the changing conditions, an impact on the electronic platform from the user obtaining the first item at a later point in time.

20. The non-transitory, computer-readable medium of claim 18, wherein the corrective action comprises implementing a platform response strategy that offsets detrimental impacts of changing conditions on an electronic platform.
